(19) United States
(12) Patent Application Publication
(10) Pub. No.: US 2002/0109508 A1
(43) Pub. Date: Aug. 15, 2002

(54) Test pen for lamp strings

(75) Inventor: Peter K. H. Huang, Taipei (TW)

Correspondence Address: DOUGHERTY & TROXELL, SUITE 1404, 5205 LEESBURG PIKE, FALLS CHURCH, VA, 22041, US

(73) Assignee: Shining Blick Enterprises Co., Ltd.

(21) Appl. No.: 09/781,943

(22) Filed: Feb. 14, 2001

(51) Int. Cl. H01H 31/02

(52) U.S. Cl. 324/556

(57) ABSTRACT

A test pen for lamp strings, comprising a main body formed from an upper and a lower housing and having therein an electric circuit board, a end cap is fit over one end of the main body, the test pen thus is adapted to be clamped on a suit of one's clothes. The upper housing is provided in a plurality of windows thereon in an exposing way with a control switch, a first and a second testing contact group for a fuse and a miniature lamp bulb respectively, and a testing contact piece provided on an end in opposition to the end cap for testing electric current on conductors. The control switch controls a display light to show normality of test members, the electric circuit board is provided with an illuminating switch to be controlled by an exposed illuminating push button to control lightening or turning off of said display light. The testing contact piece can be used as a test device for common lamp bulbs and special miniature lamp bulbs.

### BACKGROUND OF THE INVENTION

1. Field of the invention

The present invention is related to a test pen for lamp strings, and especially to a test device of which a display light can be used as a spare illumination lamp, a common lamp or a special mini-lamp on the test pen which can be carried on one's person.

2. Description of the Prior Art

A lamp string used for festivals (such as Christmas or a vacation) generally has a lot of lamp bulbs inserted in a lot of lamp holders, every inoperative miniature bulb can influence the normal function of the entire lamp string. To detect a damaged bulb on the lamp string, generally one of various test tools will be used.

Such a testing tool has been disclosed in U.S. Pat. No. 5,179,339 of Volk, wherein, two separated wire probes are provided on one end of a main body, the wire probes can be extended into an aperture of a slot of the socket of the lamp bulb, the lamp bulb can be tested for normality of function during assembling of the lamp bulb itself.

U.S. Pat. No. 5,369,363 of Hey has a hole on one end of a handle to allow each lamp bulb and its socket to be loosely positioned in the hole for testing.

U.S. Pat. No. 5,604,436 of Henritzy et al. has wire probes similar to those of Volk for insertion of the socket of a lamp bulb for testing whether there is flowing through of electric current, this patent also disclosed that a control switch is provided on the external surface thereof to control test operation.

No matter which testing tool is used to test the normality of function of every lamp bulb on a lamp string, when electric current flows through the lamp bulb or its related conductors, mostly lightening or not of a display light can show normality of a lamp bulb. U.S. Patent Des. 347,187 has a display light on the surface of its test pen, however, such display light on the test pen for a lamp string is only for simply indicating flowing through of electric current.

And more, such test pen for a lamp string such as a Christmas lamp string specially suitable for testing the miniature bulbs of fixed structural style, it can hardly be used for lamp bulbs of other types (such as those including metallic sleeves and end connecting points). And conventionally, a Christmas lamp string with miniature bulbs of special structure for assembling, such as one with an insertion-connecting piece of larger length extended from the holder of each lamp, can also hardly be tested with such a conventional test pen.

### SUMMARY OF THE INVENTION

The object of the present invention is to provide a test pen for lamp strings, wherein, the display light for testing can be individually controlled. The test pen especially suitable for carrying on one's person can use the display light as a personal auxiliary illuminating tool and can be used as a testing device for common lamp bulbs and special miniature lamp bulbs.

To get the above object, in the preferred embodiment of the present invention, the main body of the test pen is comprised of an upper and a lower housing and a end cap, the internal space formed by the upper and the lower housings has therein an electric circuit board with related circuits. The upper housing is provided with a first and a second testing contact group for an exposed fuse and a miniature lamp bulb respectively, and a testing contact piece provided on an end in opposition to the end cap; and is provided with a control switch for the display light and an exposed push button. The electric circuit board in the space formed by the upper and the lower housings is provided with an illuminating switch to be controlled by an exposed illuminating push button to control lightening or turning off of the display light.

The display light is preferably an LED with high brightness or super brightness.

In a practicable embodiment of the present invention, the upper housing where the first testing contact group for a fuse and the second testing contact group for a miniature lamp bulb locate has a corresponding window which is opened and can suit common lamp bulbs and special miniature lamp bulbs.

In a preferred embodiment of the present invention, the aforesaid illuminating switch is preferably provided with an upright elastic rod; while the illuminating push button can be snap engaged in position in a connecting hole provided on the upper housing to render the top of the upright elastic rod to be pressed against the inner top surface of the illuminating push button, thereby, the illuminating switch can be controlled by pressing the illuminating push button.

In another practicable embodiment of the present invention, the electric circuit board of the test pen can be provided on one end thereof with another LED lamp bulb, the testing contact piece provided on an end of the electric circuit board for testing electric current on the conductors is provided at a position in opposition to that of the lamp bulb with an arciform notch to allow illumination of the lamp bulb from the end of the test pen under control of the illuminating switch.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view showing a preferred embodiment of the present invention;

FIG. 2 is an analytic perspective view showing the elements of the present invention;

FIG. 3 is a sectional side view taken from FIG. 1;

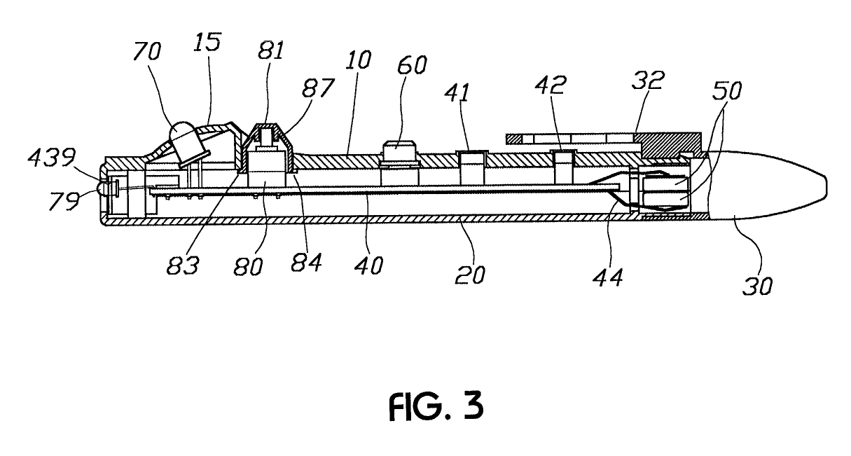

FIG. 4 is a perspective schematic view showing illumination of the embodiment of FIG. 1;

FIG. 5 is a sectional schematic view showing test of the testing contact group for a fuse of the present invention for the lamp bulbs with metallic sleeves and end connecting points; FIG. 6 is sectional schematic view showing test of the testing contact group for a miniature lamp bulb of the present invention for special miniature lamp bulbs.

### DETAILED DESCRIPTION OF THE PREFERRED EMBODIMENT

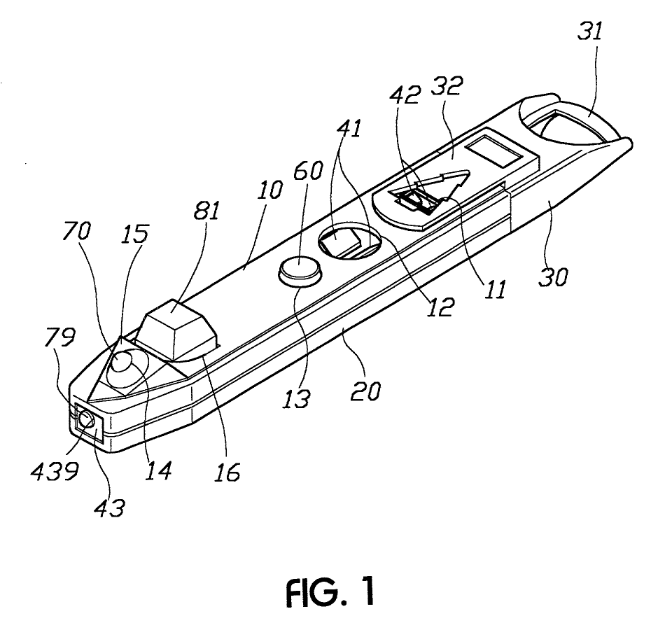

Referring to FIG. 1, 2, the present invention makes the test pen for lamp strings as a pen with suitable length and volume so that it can be carried on one's person (such as hanging by clamping it in a pocket of a shirt). In the preferred embodiment shown, the entire test pen is comprised of an upper housing 10, a lower housing 20 and a end cap 30 fitting over the two housings, the internal space formed by the upper and the lower housings 10, 20 has therein an electric circuit board 40 which takes a battery set 50 as its power source.

The electric circuit board 40 is provided on a surface thereof with related circuits, related electronic elements, a first testing contact group 41 for a fuse and a second testing contact group 42 for a miniature lamp bulb respectively, a testing contact piece 43 provided on an end of the electric circuit board 40 for testing electric current on conductors, and a battery contact piece 44 provided on the other end of the electric circuit board 40 as well as a control switch 45. In the preferred embodiment shown, when the upper and lower housings 10, 20 are assembled, the first testing contact group 41 is exposed out of a first window 11 of the upper housing 10, while the second testing contact group 42 is exposed out of a second window 12 of the upper housing 10, and the testing contact piece 43 for testing electric current on conductors is exposed out of another end of the upper housing 10. The first and second testing contact groups 41, 42 are both made from two mutually similar metallic sheets opposite to each other, the bottom ends of the metallic sheets are insertion connected with the electric circuit board 40. The top end of the first testing contact group 41 is folded at 411 (used as a contact section) to form an internally bending section 412, the contact section 411 of the first testing contact group 41 is used to test the fuse by contacting, while the internally bending section 412 is used to test common lamp bulbs. The second testing contact group 42 is similar to a test device for common miniature lamp bulbs (such as those used on a Christmas lamp string), however, the corresponding second window 12 of the upper housing 10 is totally opened to allow insertion connecting of a miniature lamp bulb of special structure. To facilitate insertion of a common miniature lamp bulb, the corresponding first window 11 of the upper housing 10 is in the shape of a round hole. A control push button 60 is positioned in a hole 13 provided on the upper housing 10 and above the control switch 45. A display light 70 is provided on an end surface of the electric circuit board 40 and is exposed out of another hole 14 on the upper housing 10, the display light 70 is preferably an LED which is provided on a beveled surface 15 to form an inclined light projecting angle with the upper housing 10.

The above mentioned end cap 30 is fit over one end of the two housings 10, 20 after assembling, and is provided with a prying plate 31 and a clip 32 integrally extending from the end cap 30, so that the clip 32 can be hung by clamping on a suit of clothes after assembling of the end cap 30.

Accordingly, the test pen having assembled primarily to render the fuse and a miniature lamp bulb to contact the first testing contact group 41 and the internally bending section 412 respectively can make the display light 70 lightened if the fuse and the lamp bulb is normal, and can make it not lightened if the fuse and the lamp bulb is abnormal when the control push button 60 is pressed down to trigger the control switch 45. Similarly, when the control push button 60 is pressed down, the testing contact piece 43 moves toward the conductors, the display light 70 is lightened or not lightened depending on whether electric current is flow therethrough.

The electric circuit board 40 of the present invention and the related circuits thereof have an illuminating switch 80 at an appropriate position to control singly the display light 70, the illuminating switch 80 can be controlled by an exposed illuminating push button 81 to control lightening or turning off of the display light 70.

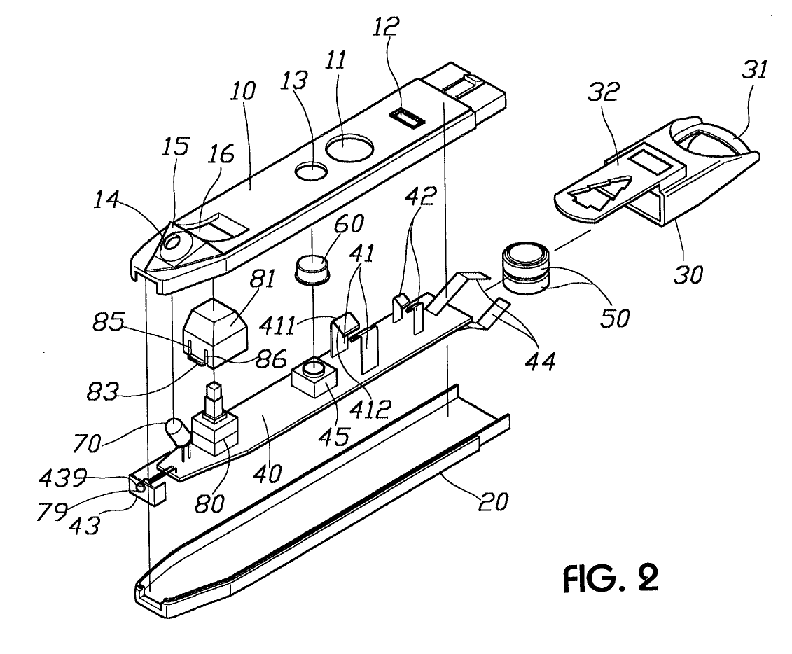

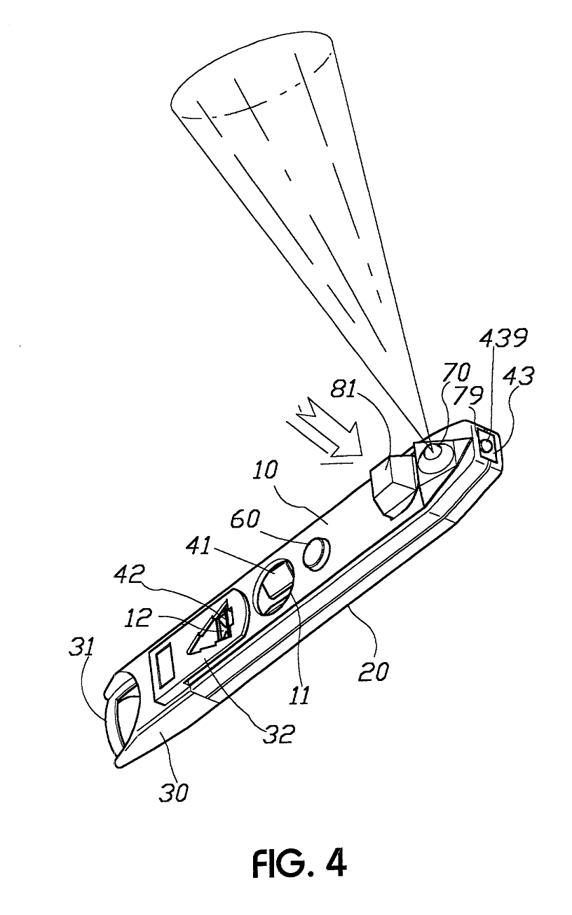

In the preferred embodiment of the present invention, the illuminating switch 80 is provided with an upright elastic rod 82, while the illuminating push button 81 can be linked in motion therewith. In this embodiment, the upper housing 10 has a connecting hole 16 provided at the rear of the beveled positioning surface 15with the display light 70 thereon. The illuminating push button 81 is provided on both lateral sides thereof with extension portions 83, 84, slits 85, 86 are formed on both sides of each extension portion 83, 84 (referring to FIG. 2). The extension portions 83, 84 are in the state of hanging in the air, thereby, they can be slightly contracted when the illuminating push button 81 is pressed into the connecting hole 16; and the illuminating push button 81 can be restored to its partially exposed position when the it gets through the connecting hole 16 by the elastic restoration of its material to be assembled and elastically engaged and positioned beneath the connecting hole 16. Under such an assembling state, the inner top surface of the illuminating push button 81 is abutted against the top end of the upright elastic rod 82 of the illuminating switch 80, so that it can move together with the upright elastic rod 82 when the illuminating push button 81 is pressed down to control on/off of the illuminating switch 80 (referring to FIG. 4). In this embodiment, in order to get a stable motion, the illuminating push button 81 is provided on the inner top surface thereof with a sleeve portion 87 for deeply slipping over the upright elastic rod 82.

In another practicable embodiment of the present invention as shown in the drawings, the electric circuit board 40 of the test pen of the present invention can be provided on the front end thereof with another LED lamp bulb 79 similarly controlled by the illuminating switch 80. The testing contact piece 43 provided on the end of the electric circuit board 40 is provided with an arciform notch 439 in association with the LED lamp bulb 79. The additional LED lamp bulb 79 is surely controlled by turning on/off of the illuminating switch 80 to allow illumination of the lamp bulb from the end of the test pen or to be extinguished.

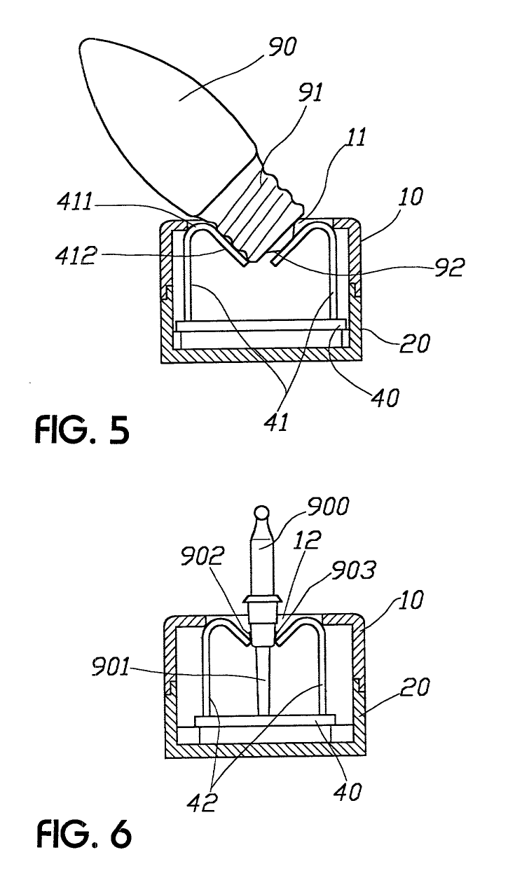

As shown in FIG. 5, the upper contact section 411 of the first testing contact group 41 can, except straddling testing the fuse, go for testing a common lamp bulb 90 obliquely disposed to have its metallic sleeve 91 abutted against an internally bending section 412 of a side of one of the contact groups. The end point 92 of the bulb 90 is abutted against the other side of the contact group to test the common lamp bulb 90. By virtue that the second window 12 of the second testing contact group 42 is totally opened, it can not only be suitable for testing a miniature lamp bulb such as a Christmas lamp bulb, as shown in FIG. 6, when it is used on a special miniature lamp bulb 900 with an insertion-connecting piece 901 of larger length, the insertion-connecting piece 901 can be inserted into the test pen through the second window 12 to render the two conductors 902, 903 on both sides of the lamp holder to abut against the second testing contact group 42 for testing.

In the recent years, by fast advancing of the technique of LED manufacturing, when the display light and the additional lamp bulb are LEDs with high brightness or super brightness, suitable illumination strength can be obtained. The improvement of design of the present invention allows the test pen for lamp strings carried on one's person being functioned as a temporary auxiliary illumination tool when is necessary; it can be effected by just pressing down the illuminating push button, and thus is quite convenient. And more, it can not only be suitable for testing a fuse of a common lamp string and a miniature lamp bulb, but also for a common lamp bulb and a special miniature lamp bulb.

The embodiments mentioned above are only for illustrating the present invention. It will be apparent to those skilled in this art that various modifications or changes can be made to the elements of the present invention without departing from the spirit and scope of this invention and fall within the scope of the appended claims and are intended to form part of this invention.

1. A test pen for lamp strings, comprising a main body formed from an upper and a lower housing and having therein an electric circuit board, a end cap is fit over one end of said main body, said test pen thus is adapted to be clamped on a suit of one's clothes; said upper housing is provided in a plurality of windows thereon in an exposing way with a control switch, a first and a second testing contact group for a fuse and a miniature lamp bulb respectively, and a testing contact piece provided on an end in opposition to said end cap for testing electric current on conductors; said control switch controls a display light to show normality of test members, said electric circuit board is provided with an illuminating switch to be controlled by an exposed illuminating push button to control lightening or turning off of said display light.

2. A test pen for lamp strings as claimed in claim 1, wherein, said display light is an LED with high brightness.

3. A test pen for lamp strings as claimed in claim 1, wherein, said LED is provided in a hole on a beveled surface of said upper housing.

4. A test pen for lamp strings as claimed in claim 1, wherein, said illuminating push button on said electric circuit board is provided with an elastic upright elastic rod linked in motion with said exposed illuminating push button.

5. A test pen for lamp strings as claimed in claim 4, wherein, said illuminating push button is engaged in position in a connecting hole provided on said upper housing, said illuminating push button is provided on both lateral sides thereof with extension portions, slits which open elastically are formed on both sides of each extension portion.

6. A test pen for lamp strings as claimed in claim 5, wherein, said illuminating push button is provided on the inner top surface thereof with a sleeve portion for deeply slipping over said upright elastic rod.

7. A test pen for lamp strings as claimed in claim 1, wherein, a first one of said windows corresponding to said first testing contact group for a fuse on said upper housing is in the shape of a round hole suiting the shape of a lamp bulb for contacting with said first testing contact group.

8. A test pen for lamp strings as claimed in claim 1, wherein, a second one of said windows corresponding to said second testing contact group for a miniature lamp bulb on said upper housing is in the shape of an opened hole to communicate with the interior of said main body.

9. A test pen for lamp strings as claimed in claim 1, wherein, said electric circuit board of said test pen is provided on the front end thereof with another LED lamp bulb similarly controlled by said illuminating switch, said testing contact piece provided for testing electric current on the said conductors is provided at a position in opposition to that of said LED lamp bulb with an arciform notch to allow illumination of said lamp bulb from said front end of said test pen.
